(19) United States
(12) Patent Application Publication
(10) Pub. No.: US 2008/0318769 A1
(43) Pub. Date: Dec. 25, 2008

(54) Catalyst and Method for Manufacturing Catalyst for Use in Exhaust Emission Control

(76) Inventors: Hironori Wakamatsu, Yokohama-shi (JP); Hirofumi Yasuda, Yokosuka-shi (JP); Kazuyuki Shiratori, Yokohama-shi (JP); Masanori Nakamura, Yokosuka-shi (JP); Toru Sekiba, Yokohama-shi (JP); Katsuo Suga, Yokohama-shi (JP)

Correspondence Address: YOUNG & BASILE, P.C., 3001 WEST BIG BEAVER ROAD, SUITE 624, TROY, MI, 48084, US

(21) Appl. No.: 11/658,810

(22) PCT Filed: Aug. 4, 2005
(86) PCT No.: PCT/IB05/02333

§ 371 Date: Jan. 29, 2007

(30) Foreign Application Priority Data
Aug. 6, 2004 (JP) 2004-23087

(51) Int. Cl. B01J 21/06; B01J 23/04; B01J 23/06; B01J 23/10; B01J 23/34; B01J 23/36; B01J 23/42; B01J 23/44; B01J 23/46; B01J 23/50; B01J 23/52; B01J 23/72; B01J 23/745; B01J 23/75; B01J 23/755; B01J 23/00

(52) U.S. Cl. 502/303; 502/349; 502/340; 502/350; 502/324; 502/355; 502/302; 502/344; 502/339; 502/325; 502/347; 502/338; 502/337; 502/345; 502/343

(57) ABSTRACT

A catalyst (1) for use in exhaust emission control that improves catalytic activity and reduces the amount of noble metal used and method for making such a catalyst (1). The catalyst (1) includes a noble metal first constituent (2); a transition metal compound second constituent (3), part or all of which forms a complex with the noble metal; a third constituent element (4) that is in contact with the complex and has an electronegativity of 1.5 or less; and a porous carrier (5) that supports the noble metal, the transition metal compound and the third constituent element (4), and that is such that part or all of which forms a complex oxide with the third constituent element (4).

### FIELD OF THE INVENTION

This invention relates to a catalyst for use in exhaust emission control and a method for manufacturing such a catalyst, and particularly to a catalyst for use in exhaust emission control that controls emissions in exhaust from internal combustion engines.

### BACKGROUND OF THE INVENTION

Automobile exhaust emission controls have expanded worldwide. One form of emission control utilizes a so-called catalytic combustion or converter device incorporated into the exhaust system of motor vehicles powered by an internal combustion engine. The catalysts typically consist of particles of Pt (platinum), Pd (palladium), Rh (rhodium) and other noble metals supported by a porous carrier made of alumina (Al₂O₃) or other oxides. The carrier is often coated on a substrate such as a honeycomb made of cordierite. The amount of the noble metals used per automobile has been increasing in response to stricter exhaust emission controls, resulting In increasing costs per vehicle. In addition, noble metals are also used as catalysts in fuel cell technology that has attracted attention as a means of addressing the current global energy resource problems. Thus, the exhaustion of resources of the noble metals is a problem, along with the increasing costs as demand for them increases. For these reasons it is desirable to reduce the quantity of noble metals used as catalysts in motor vehicle applications.

The catalytic activity of noble metals is roughly proportional to the exposed surface area of the noble metal, since catalytic reactions provided by noble metals are contact reactions wherein the reaction proceeds on the active surface of the noble metal. For this reason, in order to obtain the greatest extent of catalytic activity from a small amount of noble metal, it is necessary to fabricate particles of noble metal that have a small grain size and high specific surface area.

However, in the case of minute particles in which the noble metal grain size is 1 nanometer (nm) or smaller, the surface reactivity of the noble metal particle is high and the noble metal particle has a large surface energy, so they are extremely unstable. For this reason, particles of noble metals readily cohere to each other (by sintering) when brought together at high temperature. Pt in particular undergoes marked sintering when heated, so even when supported on a carrier In a dispersed manner, sintering causes grains to coalesce and thus the average grain size increases and thus the catalytic activity decreases. Catalysts for use in automobiles are typically subjected to high temperatures in the range of 800-900° C., or even in excess of 1000° C. Accordingly, it is difficult to maintain catalytic activity of minute particle states. For this reason, the sintering of noble metal particles is difficult to overcome in providing a catalyst for use in exhaust emission control that contains only small amounts of noble metals.

In order to limit the use of noble metals, efforts have been made to develop inexpensive catalyst materials which do not use noble metals. For example, if transition metals or the like can be utilized as catalyst materials, it is possible to reduce costs greatly. However, transition metals alone have not been demonstrated to have adequate catalytic activity, and even if the catalytic activity is improved by any of the conventional methods, reductions in the amount of noble metals used have not been achieved. Up until now, catalysts that use noble metals together with other, less costly metals have been proposed. For example, as suggested in Japanese patent application (Kokai) No. JP-A-S59-230639, a catalyst has been proposed comprising activated alumina and at least one or more elements selected from among the group of Ce (cerium), Zr (zirconium), Fe (iron) and Ni (nickel); along with, if necessary, at least one element selected from among the group of Nd (neodymium), La (lanthanum) and Pr (praseodymium); and also at least one element selected from among the group of Pt, Pd and Rh; that are supported on a honeycomb substrate. In another approach taught by Japanese Patent No. 3,251,009, a catalyst for use in exhaust emission control is described having a composition wherein oxides of at least one or more elements selected from among the group of Co (cobalt), Ni, Fe, Cr (chromium) and Mn (manganese); and at least one of Pt, Rh or Pd are in solid solution with each other at the interface of contact with each other.

### SUMMARY OF THE INVENTION

The present invention addresses the previously described shortcomings of the prior art. One aspect of the invention is a catalyst for use in exhaust emission control that includes: a noble metal first constituent; a transition metal compound second constituent, part or all of which forms a complex with the noble metal; a third constituent element that is in contact with the noble metal-transition metal compound complex and has an electronegativity of 1.5 or less; and a porous carrier that supports the first, second and third constituents, such that part or all the carrier forms a complex oxide with the third constituent element. With the catalyst for use in exhaust emission control according to this invention, the transition metal compound exhibit catalytic activity, so it is possible to increase the catalytic activity of the catalyst while reducing the amount of noble metal used.

Accordingly, in this first aspect the present invention is a catalyst for use in exhaust emission control comprising: a porous carrier; a first constituent including a noble metal supported on the porous carrier; a second constituent including a transition metal compound supported on the porous carrier, such that the first constituent and the second constituent form a first constituent-second constituent complex; and a third constituent element having an electronegativity of about 1.5 or less supported on the porous carrier, the third constituent element being in contact with at least a portion of the first constituent-second constituent complex.

In another aspect, at least a portion of the third constituent element is impregnated into the porous carrier.

A further aspect of the invention is such that at least a portion of the third constituent element forms a complex oxide with the porous carrier.

Yet another aspect of the invention is that at least a portion of the first constituent-second constituent complex is deposited on the third constituent element.

In an additional aspect, the noble metal is selected from the group consisting of ruthenium, rhodium, palladium, silver, iridium, platinum, gold, and mixtures thereof.

Still another aspect of the invention is that the transition metal compound includes a transition metal selected from the group consisting of manganese, iron, cobalt, nickel, copper, zinc, and mixtures thereof.

It is also an aspect of the invention that the third constituent element is selected from the group consisting of manganese, titanium, zirconium, magnesium, yttrium, lanthanum, cerium, praseodymium, neodymium, calcium, strontium, barium, sodium, potassium, rubidium, cesium, and mixtures thereof.

In a further aspect, the third constituent element has an electronegativity of about 1.2 or less.

Still another aspect is that the transition metal compound includes a transition metal, the transition metal has a 2p binding energy having a first value (B₂), the transition metal in a metallic state has a 2p binding energy having a second value (B₁), and the difference between B₂ and B₁ (B₂−B₁) is 3.9 eV or less.

In yet another aspect the noble metal is present in an amount of about 0.7 grams or less per 1 liter volume of the catalyst.

It is also an aspect of the invention that the first constituent-second constituent complex is homogeneous.

A second aspect of this invention is a method for manufacturing a catalyst for use in exhaust emission control that comprises the steps of: causing a constituent element that has an electronegativity of 1.5 or less to impregnate and be supported by a porous carrier, forming a complex between the constituent element and the porous carrier; and then causing a noble metal and a transition metal compound both to impregnate the porous carrier. In accordance with this aspect of the invention, a constituent element with an electronegativity of 1.5 or less is impregnated into and supported by the porous carrier prior to causing the noble metal and transition metal compounds to impregnate the carrier, so the noble metal-transition meal compound complex can be put in contact with the complex oxide of the third constituent element and the porous carrier.

Accordingly, in this aspect of the invention the present invention is a method of manufacturing a catalyst for use in exhaust emission control, the method comprising the steps of: impregnating a porous carrier with a constituent element having an electronegativity of about 1.5 or less; subsequently loading the porous carrier with a first constituent including a noble metal and a second constituent including a transition metal compound such that the first constituent and the second constituent form a complex, and such that the first constituent-second constituent complex is in contact with at least a portion of the constituent element.

In another aspect of the method of the invention, at least a portion of the constituent element forms a complex oxide with porous carrier.

In a further aspect of the method, the noble metal is selected from the group consisting of ruthenium, rhodium, palladium, silver, iridium, platinum, gold, and mixtures thereof.

In yet another aspect of the method, the transition metal compound includes a transition metal selected from the group consisting of manganese, iron, cobalt, nickel, copper, zinc, and mixtures thereof.

It is also an aspect of the method of the invention that the constituent element is selected from the group consisting of manganese, titanium, zirconium, magnesium, yttrium, lanthanum, cerium, praseodymium, neodymium, calcium, strontium, barium, sodium, potassium, rubidium, cesium, and mixtures thereof.

In another aspect of the method, the constituent element has an electronegativity of about 1.2 or less.

In a further aspect of the method of the invention, the transition metal compound includes a transition metal, the transition metal has a 2p binding energy having a first value (B₂), the transition metal In a metallic state has a 2p binding energy having a second value (B₁), and the difference between B₂ and B₁ (B₂−B₁) is 3.9 eV or less.

In yet another aspect of the method, the step of loading the porous carrier with the first constituent including a noble metal includes loading the porous carrier with one or more noble metals present in an amount of about 0.7 grams or less per 1 liter volume of the catalyst.

Still another aspect of the method of the invention, the first constituent-second constituent complex is homogeneous.

### BRIEF DESCRIPTION OF THE DRAWINGS

Further objects, features and advantages of the present invention will become apparent from consideration of the following description and the claims when taken in connection with the accompanying drawings.

FIG. 1 is a schematic partial cross section illustrating an embodiment of the catalyst for use in exhaust emission control according to the present invention.

FIG. 2 is an explanatory diagram illustrating the relationship between the Pt loading and the CO conversion rate for catalysts in accordance with this invention and those for comparative examples.

FIG. 3(a) is an explanatory diagram illustrating the mechanism of removal of emissions by the catalyst for use in exhaust emission control obtained according to Working Example 1;

FIG. 3(b) is an explanatory diagram Illustrating the mechanism of removal of emissions by the catalyst for use in exhaust emission control obtained according to Comparative Example 2;

FIG. 3(c) is an explanatory diagram illustrating the mechanism of removal of emissions by the catalyst for use in exhaust emission control obtained according to the Reference Example;

FIG. 4(a) is an explanatory diagram illustrating the relationship between the NOₓ conversion rate and the electronegativity of the third constituent element contained in the catalyst for use in exhaust emission control;

FIG. 4(b) is an explanatory diagram illustrating the relationship between the CO conversion rate and the electronegativity of the third constituent element contained in the catalyst for use in exhaust emission control;

FIG. 4(c) is an explanatory diagram illustrating the relationship between the C₃H₆ conversion rate and the electronegativity of the third constituent element contained in the catalyst for use in exhaust emission control.

FIG. 5(a) is an explanatory diagram illustrating the relationship between the NOₓ conversion rate and the value of the 4d binding energy of a noble metal within the catalyst for use in exhaust emission control;

FIG. 5(b) is an explanatory diagram illustrating the relationship between the Co conversion rate and the value of the 4d binding energy of a noble metal within the catalyst for use in exhaust emission control;

FIG. 5(c) is an explanatory diagram illustrating the relationship between the C₃H₆ conversion rate and the value of the 4d binding energy of a noble metal within the catalyst for use in exhaust) emission control.

FIG. 6(a) is an explanatory diagram illustrating the relationship between the NOₓ conversion rate and the value of the 2p binding energy of a transition metal compound within the catalyst for use in exhaust emission control;

FIG. 6(b) is an explanatory diagram illustrating the relationship between the CO conversion rate and the value of the 2p binding energy of a transition metal compound within the catalyst for use in exhaust emission control; and

FIG. 6(c) is an explanatory diagram Illustrating the relationship between the C₃H₆ conversion rate and the value of the 2p binding energy of a transition metal compound within the catalyst for use in exhaust emission control.

### DETAILED DESCRIPTION OF THE INVENTION

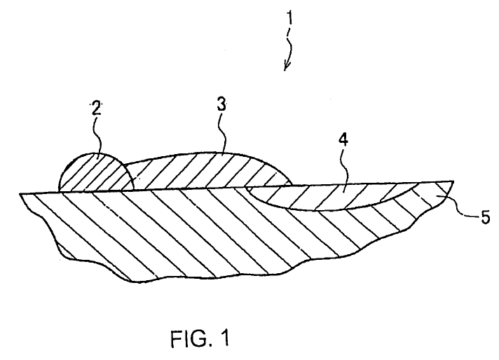

As shown in FIG. 1, the catalyst 1 for use in exhaust emission control according to the present invention is characterized as having a noble metal first constituent 2; a second constituent in the form of a transition metal compound 3, part or all of which forms a complex with the noble metal 2; a third constituent element 4 that Is in contact with the noble metal-transition metal compound complex and has an electronegativity of 1.5 or less; and a porous carrier 5 that supports the noble metal 2, the transition metal compound 3 and the third constituent element 4, part or all of which forms a complex oxide with the third constituent element 4.

Catalyst 1 is provided to promote certain exhaust emission control chemical reactions, namely the reactions that remove hydrocarbons (HC), carbon monoxide (CO) and nitrogen oxides (NOₓ), which are the harmful constituents in internal combustion engine exhaust gases, are those indicated by Equation (1) through Equation (4) below.

CO+1/2O₂→CO₂ Equation (1)

NOₓ+H₂→N₂+H₂O Equation (2)

NOₓ+CO→CO₂+N₂ Equation (3)

HC+O₂→H₂O+CO₂ Equation (4)

Here, the various harmful constituents react upon being adsorbed to the noble metal that alone should have a high activity, but referring to FIG. 1, the catalytic performance is improved by the noble metal 2 being in contact with and forming a complex with the transition metal compound 3 which alone does not readily exhibit catalytic activity. At least one reason for this activity is thought to be a phenomenon called “spillover” wherein, under the so-called stoichiometric conditions where the oxygen/reducing agent ratio in the motor vehicle exhaust is equal, for example, the exhaust gas is first dissociated and adsorbed to the surface of the noble metal 2 and is then transferred to the surface of the transition metal compound 3, so emissions are removed from the exhaust gas upon the surface of the transition metal compound 3. By the noble metal 2 and transition metal compound 3 coming into contact with and forming a noble metal-transition metal compound complex with each other, the noble metal 2 acts not only as a catalyst but also as the main site for adsorbing exhaust gas, so the transition metal compound 3 within the noble metal-transition metal compound complex is activated and functions as a site for surface reaction, thus acting as a catalyst. In this way, the effect of the transition metal compound 3 complementing the catalytic activity of the noble metal 2 is obtained, so the amount of noble metal 2 used can be reduced.

By forming a state in which the exhaust gas can easily reach the transition metal compound 3 in this manner, a state in which exhaust emission removal activity by reduction is readily obtained, the exhaust gas emission catalytic activity is improved. Note that as the porous carrier 5, a porous ceramic substance such as alumina (aluminum oxide) or the like may be used as well as other porous carriers as would be known by those with skill in the art with the present disclosure before them.

As used in this description, a “complex” refers to a state such as that diagrammatically shown in FIG. 1, wherein the noble metal 2 and the transition metal compound 3 components of the catalyst 1 are in a state of contact on the same porous carrier 5. As described above, when the noble metal 2 and the transition metal compound 3 are in a state of contact, the transition metal compound is activated by spillover and acts as a catalyst site that induces catalyzed reactions, so the catalytic activity is increased.

In addition, as shown in FIG. 1, when the noble metal 2 and transition metal compound 3 are supported upon the porous carrier 5, part or all of which forms a complex oxide with the third constituent element 4 having an electronegativity of 1.5 or less, and the third constituent element 4 is in contact with the noble metal-transition metal compound complex, the catalytic activity is further maintained and the amount of noble metal 2 used can be further reduced. Another reason for this activity is thought to be that with the presence of the third constituent element 4, the transition metal compound 3 has its oxidation state altered so that a reducing state with little oxygen present is formed on the surface of the transition metal compound 3, and this promotes surface reactions on the transition metal compound 3, thus activating it as a catalyst. In addition, considering that the oxidation/reduction state of the noble metal 2 is virtually unchanged by the addition of the third constituent element 4, the third constituent element 4 is thought to be effective in activation of the transition metal compound 3. Moreover, the third constituent element 4 may suppress the formation of complex oxides between the transition metal compound 3 and porous carrier 5. Additionally, the oxidation/reduction reaction characteristic of the transition metal compound 3 is thought to be increased by the conversion of the transition metal compound 3 to an active state.

The usable noble metals 2 and transition metal compounds 3 for catalyst 1, in accordance with this invention, may be selected from a range of combinations of elements to obtain similar effects. This is thought to be because the noble metal elements and the transition metal elements within the transition metal compounds 3 exhibit the same electronic state.

The third constituent element 4 is preferably an element that has a Pauling electronegativity of 1.5 or less. These elements are elements that have a relatively small electronegativity and readily give up electrons. In an ordinary atmosphere, the transition metals are stable in the oxidized state, so they are in a state that readily forms an oxide or compound with the porous carrier 5. Here, by adding the third constituent element 4, oxygen within the transition metal compound 3 is used for the oxidation of the third constituent element 4, and as a result, the oxygen upon the transition metal compound 3 is removed, causing the transition metal compound 3 to be activated as a catalyst. If the electronegativity of the third constituent element 4 is greater than 1.5, the catalytic activity conversely decreases. The reason for this is thought to be because the ability to give up oxygen to the transition metal compound 3 increases so deactivation of the transition metal compound proceeds.

The electronegativity of the third constituent element 4 is even more preferably 1.2 or less. If the electronegativity of the third constituent element 4 is 1.5 for example, while it may be effective with respect to the HC removal performance, which is one of the three types of catalytic activity of a three way catalyst, adequate effectiveness with respect to the other two types of performance, namely CO and NOₓ removal performance cannot be obtained. On the other hand, if the electronegativity of the third constituent element is 1.2 or less, adequate increases in the three types of activity performance, namely HC, CO and NOₓ removal performance, can be obtained. The reason for this is thought to be because the electronegativity of the third constituent element changes the oxidation/reduction state of the transition metal compound within the noble metal-transition metal compound complex, having an effect on the activation with respect to HC in particular. Note that this effect is seen not only in the so-called three way catalysts that remove HC, CO and NOₓ simultaneously, but it is also effective with respect to the removal of each of the respective harmful component gases individually, so the same effect can be obtained in oxidation catalysts that remove only HC and CO in an oxygen-rich atmosphere, HC adsorption catalysts that combine HC adsorbents and three way catalysts, and NOₓ adsorption catalysts that remove NOₓ by repeatedly cycling between rich/lean atmospheres. In addition, with the catalyst 1 for use in exhaust emission control according to this embodiment, the sites for catalytic activity are increased, so naturally it will also be effective with respect to emission control for the exhaust from methanol reformation type fuel cells.

A portion of the transition metal compound 3 may be in the metal (0 valence) state, or part or all thereof may be in the simple oxide, compound oxide or alloy states. Note that in the case that part of the transition metal compound 3 is in the metal state, the catalytic activity may be higher and the exhaust emission control efficiency may be improved in comparison to the case in which it is all oxide. In addition, in the case that the complex between the noble metal 2 and the transition metal compound 3 is heterogeneous, there may be cases in which a portion of the transition metal compound 3 forms a solid solution with the porous carrier 5, thus forming enlarged particles of the transition metal. In this case, reduced contact between the noble metal 2 and the transition metal compound 3 or reduced probability of contact with the reaction gases may occur, so the noble metal-transition metal compound complex is preferably as homogeneous as possible.

The noble metal 2 is preferably a noble metal selected from among the group of Ru (ruthenium), Rh (rhodium), Pd (palladium), Ag (silver), Ir (iridium), Pt (platinum) and Au (gold), and may also be a mixture of two or more noble metals, e.g. Pt and Rh.

The transition metal compound 3 preferably contains a transition metal selected from among the group of Mn (manganese), Fe (Iron), Co (cobalt), Ni (nickel), Cu (copper) and Zn (zinc), and may also be a mixture of two or more transition metals. The third constituent element 4 is preferably an element selected from among the group of Mn (manganese), Ti (titanium), Zr (zirconium), Mg (magnesium), Y (yttrium), La (lanthanum), Ce (cerium), Pr (praseodymium), Nd (neodymium), Ca (calcium), Sr (strontium), Ba (barium), Na (sodium), K (potassium), Rb (rubidium) and Cs (cesium), and may also be a mixture of two or more of these elements. Note that Mn (manganese) may be used both as the part of transition metal compound 3 and also as the third constituent element 4.

Moreover, the value of the 2p binding energy of the transition metal within the transition metal compound 3 within the catalyst 1 for use in exhaust emission control (B₂) and the value of the 2p binding energy of this transition metal in the metallic state (B₁) as measured by X-ray photoelectron spectroscopy are preferably such that their difference (B₂−B₁) is 3.9 eV or less. If the difference (B₂−B₁) is 3.9 eV or less, this is thought to suppress the transition metal compound 3 forming a solid solution with the porous carrier 5 and/or preventing a highly oxidized state from occurring, and is also thought to maintain the active species.

The catalyst 1 for use in exhaust emission control according to this invention is particularly effective as a Pt alternative technology. The oxidation/reduction state of the transition metal compound 3 is changed by means of the third constituent element 4 as described above, and the electronic states of the transition metals are very similar to each other, so the same effect of catalytic activation of the transition metal compound by the third constituent element 4 can be obtained using any transition metal. On the other hand, even further increases in the catalytic activity can be expected when using transition metal compounds that complement the activity of Pt in particular among the noble metals, along with third constituent elements 4 within this range, e.g. Ba, Ce and other basic elements.

With the catalyst 1 for use in exhaust emission control according to this invention, effects are particularly marked when the noble metal 2 is present in the amount of 0.7 grams (g) or less per 1 liter (L) volume of the catalyst for use in exhaust emission control. While adequate catalyst activity had not been previously obtained when the noble metal alone is present in the amount of 0.7 g or less per 1-L volume of the catalyst for use in exhaust emission control, in the case that a transition metal compound 3 and third constituent element 4 are used as described above, the effect of the transition metal compound 3 complementing the catalytic activity of the noble metal 2 is obtained, so even if the amount of noble metal used is reduced, adequate catalytic activity can be obtained. The reason for this is thought to be as follows. In regions where the amount of noble metal 2 is large which serve as the main sites of catalytic reactions, the cycle of adsorption, surface reaction and disassociation occurs mainly upon the noble metal. In contrast, when the amount of noble metal becomes lesser, the reaction comes to proceed further upon the transition metal compound 3 via the noble metal 2, so the effect appears in a pronounced manner when the transition metal compound is used as an alternate for noble metal. Because of the presence of the third constituent element 4 which changes the oxidation/reduction state of the transition metal compound 3, it is thought that the activation of the transition metal compound described above is promoted and catalytic activity can be expected even in the case when the amount of noble metal is reduced.

Another aspect of this invention is a method for manufacturing a catalyst 1 for use in exhaust emission control. A description of this method refers to FIG. 1 as discussed previously and the components of catalyst 1 as numbered and described above. The method for manufacturing a catalyst 1 for use in exhaust emission control according to this embodiment is characterized by the steps of: causing a third constituent element 4 that has an electronegativity of 1.5 or less to impregnate and be supported by a porous carrier 5, forming a complex between the third constituent element and the porous carrier 5, by sintering at a high temperature of roughly 600° C., and then, causing the noble metal 2 and a transition metal compound 3 both to impregnate the porous carrier 5, so it is possible to cause a complex of the noble metal 2 and transition metal compound 3 to come in contact with the complex oxide between the third constituent element and the porous carrier. In addition, the formation of a solid solution by the transition metal compound 3 with the porous carrier 5 is suppressed, and moreover, the presence of the third constituent element promotes the activation of the transition metal compound 3, so the catalytic activity can be maintained even in the case that the amount of noble metal 2 is reduced.

In contrast to the method according with this invention, if the noble metal 2 and transition metal compound 3 are made to impregnate the porous carrier 5 first and then the third constituent element 4 is made to impregnate and be supported by a porous carrier 5, the noble metal and transition metal compound which are the sites of catalytic activity would be covered by the third constituent element, so adequate catalytic activity would not be obtained.

Here follows a further detailed description of the catalyst 1 according to the present invention made with reference to the following Working Examples 1-7, Comparative Examples 1-6 and a Reference Example, but the scope of the present invention is in no way limited to these Examples. These Examples are presented to examine the effectiveness of the catalyst 1 according to the present invention, being ones that illustrate examples of catalyst for use in exhaust emission control when modified for use with different materials.

### WORKING EXAMPLE 1

The first step involves preparation of Pt (0.3 wt. %)-Co (5.0 wt. %)-Ce (8.8 wt. %)-Al₂O₃ Powder. Alumina with a specific surface area of 200 m²/g is soaked in and impregnated with an aqueous solution of cerium acetate, dried overnight at 120° C. and fired for 3 hours at 600° C. to obtain a powder. At that time, powder loaded with 8.8 wt. % of Ce when converted to the oxide was obtained. This powder is soaked in and impregnated with a mixed aqueous solution of dinitrodiammine platinum and cobalt nitrate so as to become 0.3 wt. % Pt and 5.0 wt. % Co when converted to metal. Thereafter it is dried overnight at 120° C. and fired for 1 hour at 400° C. to obtain a catalyst powder.

A second step involves coating of the honeycomb. 50 g of the catalyst powder obtained in the first step above, 5 g of boehmite and 157 g of an aqueous solution containing 10% nitric acid are placed in a ceramic pot (mill) made of alumina, shaken together with an alumina ball and crushed to obtain a catalyst slurry. Next, the catalyst slurry thus obtained was made to adhere to 0.0595 L of a honeycomb carrier (400 cells/6 mil) made of cordierite and excess slurry within the cells was removed by a flow of air. Moreover, after drying at 120° C., firing is performed for 1 hour at 400° C. in a flow of air. The amount of catalyst coated onto the catalyst-loaded honeycomb obtained at this time was 100 g/L of catalyst, and the Pt load was 0.3 g/L of catalyst. Note that “cells” represents the number of cells per square inch (˜2.54 cm), and “mil” represents the wall thickness of the honeycomb, where 1 mil is a unit of length equal to 1/1000 inch (˜25.4 μm).

### WORKING EXAMPLE 2

The same process as in Working Example 1 is performed using barium acetate instead of the cerium acetate of Working Example 1 to obtain alumina with a Ba load of 7.8 wt. % when converted to oxide. Thereafter a honeycomb was coated in the same manner as in Working Example 1 to obtain the sample of Working Example 2.

### WORKING EXAMPLE 3

The same process as in Working Example 1 is performed using praseodymium acetate instead of the cerium acetate of Working Example 1 to obtain alumina with a Pr load of 8.8 wt. % when converted to oxide. Thereafter a honeycomb was coated in the same manner as in Working Example 1 to obtain the sample of Working Example 3.

### WORKING EXAMPLE 4

The same process as in Working Example 1 is performed using titanium oxalate instead of the cerium acetate of Working Example 1 to obtain alumina with a Ti load of 4.0 wt. % when converted to oxide. Thereafter a honeycomb was coated in the same manner as in Working Example 1 to obtain the sample of Working Example 4.

### WORKING EXAMPLE 5

The powder of Working Example 1 was soaked in and impregnated with a mixed aqueous solution of dinitrodiammine platinum and cobalt nitrate so as to give a Pt loading of 0.7 wt. % when converted to metal. Thereafter the same process as in Working Example 1 was performed to obtain the sample of Working Example 5.

### WORKING EXAMPLE 6

The powder of Working Example 1 was soaked in and impregnated with a mixed aqueous solution of dinitrodiammine platinum and cobalt nitrate so as to give a Pt loading of 3.0 wt. % when converted to metal. Thereafter the same process as in Working Example 1 was performed to obtain the sample of Working Example 6.

### WORKING EXAMPLE 7

A first step involves preparation of Pd (0.3 wt. %)-Mn (5.0 wt. %)-Ba (7.8 wt. %)-Al₂O₃ Powder. Alumina with a specific surface area of 200 m²/g is soaked in and impregnated with an aqueous solution of barium acetate, dried overnight at 120° C. and fired for 3 hours at 600° C. to obtain a powder. At this time, powder with a Ba load of 7.8 wt. % of the alumina when converted to the oxide was obtained. This powder is soaked in and impregnated with a, mixed aqueous solution of palladium nitrate and manganese nitrate so as to become 0.3 wt. % Pd and 5.0 wt. % Mn when converted to metal. Thereafter it is dried overnight at 120° C. and fired for 1 hour at 400° C. to obtain a catalyst powder. Thereafter the same process as in Working Example 1 was performed and a honeycomb was coated with the catalyst powder thus obtained to obtain the sample of Working Example 7.

### COMPARATIVE EXAMPLE 1

A first step involves preparation of Pt (0.3 wt. %)-Co—Al₂O₃ Powder. First, 100 g of alumina with a specific surface area of 200 m²/g is soaked in and impregnated with an aqueous solution of dinitrodiammine platinum, dried overnight at 120° C. and fired for 1 hour at 400° C. to obtain alumina powder loaded with 0.3 wt. % Pt when converted to the metal. A second step involves coating of the honeycomb. 50 g of the catalyst powder obtained in the first step above, 5 g of boehmite and 157 g of an aqueous solution containing 10% nitric acid are placed in a ceramic pot (mill) made of alumina, shaken together with an alumina ball and crushed to obtain a catalyst slurry. Next, the catalyst slurry thus obtained was made to adhere to 0.0595 L of a honeycomb carrier (400 cells/6 mil) made of cordierite and excess slurry within the cells was removed by a flow of air. Moreover, after drying at 120° C., firing is performed for 1 hour at 400° C. in a flow of air. The amount of catalyst coated onto the catalyst-loaded honeycomb obtained at this time was 110 g/L of catalyst, and the Pt load was 0.3 g/L of catalyst.

### COMPARATIVE EXAMPLE 2

A first step involves preparation of Pt (0.3 wt. %)-Co (5.0 wt. %)-Al₂O₃ Powder. First, 100 g of alumina with a specific surface area of 200 m²/g is soaked in and impregnated with a mixed aqueous solution of aqueous dinitrodiammine platinum and cobalt nitrate, dried overnight at 120° C. and fired for 1 hour at 400° C. to obtain alumina powder loaded with 0.3 wt. % of Pt and 5.0 wt. % of Co, respectively, when converted to the metal.

A second step involves coating of the honeycomb. 50 g of the catalyst powder obtained in the first step, 5 g of boehmite and 157 g of an aqueous solution containing 10% nitric acid are placed in a ceramic pot (mill) made of alumina, shaken together with an alumina ball and crushed to obtain a catalyst slurry. Next, the catalyst slurry thus obtained was made to adhere to 0.0595 L of a honeycomb carrier (400 cells/6 mil) made of cordierite and excess slurry within the cells was removed by a flow of air. Moreover, after drying at 120° C., firing is performed for 1 hour at 400° C. in a flow of air. The amount of catalyst coated onto the catalyst-loaded honeycomb obtained at this time was 110 g/L of catalyst, and the Pt load was 0.3 g/L of catalyst.

### COMPARATIVE EXAMPLE 3

The same process as in Working Example 1 is performed using ammonium molybdate instead of the cerium acetate of Working Example 1 to obtain alumina loaded with 6.5 wt. % of Mo when converted to oxide. Thereafter a honeycomb was coated in the same manner as in Working Example 1 to obtain the sample of Comparative Example 3.

### COMPARATIVE EXAMPLE 4

The same process as in Comparative Example 1 is performed except that the Pt loading was changed to 0.7 wt. % to obtain alumina powder loaded with 0.7 wt. % of Pt when converted to metal. Thereafter the same process as In Working Example 1 was performed to obtain the sample of Comparative Example 4.

### COMPARATIVE EXAMPLE 5

The same process as in Comparative Example 1 is performed except that the Pt loading was changed to 3.0 wt. % to obtain alumina powder loaded with 3.0 wt. % of Pt when converted to metal. Thereafter the same process as in Comparative Example 1 was performed to obtain the sample of Comparative Example 5.

### COMPARATIVE EXAMPLE 6

A first step involves preparation of Pd (0.3 wt. %)-Mn (5.0 wt. %)—Al₂O₃ Powder. First, 100 g of alumina with a specific surface area of 200 m²/g is soaked in and impregnated with a mixed aqueous solution of aqueous palladium nitrate and manganese nitrate, dried overnight at 120° C. and fired for 1 hour at 400° C. to obtain alumina powder loaded with 0.3 wt. % of Pd and 5.0 wt. % of Mn, respectively, when converted to metal. Thereafter the same process as in Comparative Example 2 was performed and a honeycomb was coated with the catalyst powder thus obtained to obtain the sample of Comparative Example 6.

### REFERENCE EXAMPLE

A first step is the preparation of Pt (0.3 wt. %)-Co (5.0 wt. %)-Ce (8.8 wt. %)-Al₂O₃ Powder. Alumina with a specific surface area of 200 m²/g is soaked in and impregnated with a mixed aqueous solution of dinitrodiammine platinum and cobalt nitrate to obtain alumina powder loaded with 0.3 wt. % of Pt and 5.0 wt. % of Co, respectively, when converted to metal. This powder is further soaked in and impregnated with an aqueous solution of cerium acetate so as to become 8.8 wt. % when converted to oxide. Thereafter it is dried overnight at 120° C. and fired for 1 hour at 400° C. to obtain a catalyst powder.

A second step involves the coating of the honeycomb. 50 g of the catalyst powder obtained in step 1, 5 g of boehmite and 157 g of an aqueous solution containing 10% nitric acid are placed in a ceramic pot (mill) made of alumina, shaken together with an alumina ball and crushed to obtain a catalyst slurry. Next, the catalyst slurry thus obtained was made to adhere to 0.0595 L of a honeycomb carrier (400 cells/6 mil) made of cordierite and excess slurry within the cells was removed by a flow of air. Moreover, after drying at 120° C., firing is performed for 1 hour at 400° C. in a flow of air. The amount of catalyst coated onto the catalyst-loaded honeycomb obtained at this time was 110 g/L of catalyst, and the Pt load was 0:3 g/L of catalyst.

### Testing

The samples obtained by the methods of preparing samples listed above were evaluated by the following tests.

### Catalyst Heat Resistance Test

The catalyst powder thus obtained was fired for 1 hour at 700° C. in an oxygen atmosphere.

### Catalyst Evaluation Test

A portion of the catalyst carrier subjected to the above heat resistance test was gouged out and catalyst evaluation was performed taking 40 mL to be the catalyst volume. The flow rate of the reaction gas was 40 L/min, the reaction gas temperature was 250° C., and the evaluation was performed with the composition of the reaction gas set to a stoichiometric composition where the amount of oxygen and amount of reducing agent are equal as shown in Table 1 below. Of these, at the time of stabilization of the respective concentrations of NOₓ, CO and C₃H₆ at the catalyst inlet and the respective concentrations of NOₓ, CO and C₃H₆ at the catalyst outlet, the various conversion rates (%) were calculated from their ratios.

TABLE 1
Reaction Gas Composition (40 L/min)

| Gas composition | Stoichiometric amount |
|---|---|
| NO (ppm) | 1000 |
| CO (%) | 0.6 |
| H₂ (%) | 0.2 |
| O₂ (%) | 0.6 |
| CO₂ (%) | 13.9 |
| C₃H₆ (ppm C) | 1665 |
| H₂O (%) | 10 |
| N₂ (balance) | Remainder |

Catalyst: 40 ml

### Measurement of Binding Energy

X-ray photoelectron spectroscopy (XPS) was used to perform qualitative and quantitative evaluations of the elements of the samples and analysis of states. The system used was a PHI composite surface analysis Model 5600 ESCA system and under conditions of an X-ray source of an Al—Kα beam (1486.6 eV, 300 W), photoelectron separation angle of 45° (measurement depth of 4 nm) and measurement area of 2 mm×0.8 mm, measurement was performed with the samples affixed upon indium (In) foil. In addition, at the time of measurement, the XPS measurement was performed after exposing the sample to hydrogen (hydrogen 0.2%/nitrogen) as one exhaust gas composition within a pretreatment chamber attached to the XPS system.

Table 2 below presents, for Working Examples 1-7, Comparative Examples 1-6 and the Reference Example, the noble metal loading (%), transition metal loading (%) and third constituent element loading (%) per liter of catalyst, the electronegativity of the third constituent element, amount of catalyst coated (excluding the boehmite content) and the conversion rates (%) at 250° C.

TABLE 2

| | | | | | | | | | Conversion rate | | |
|---|---|---|---|---|---|---|---|---|---|---|---|
| | Noble metal | | Transition metal | | Third constituent element | | | Amount of | (250° C.) | | |
| | | Loading | | Loading | | Loading | | catalyst | NO_{X} | CO | C₃H₆ |
| | Element | (%) | Element | (%) | Element | (%) | Electronegativity | coated | (%) | (%) | (%) |
| Working | Pt | 0.3 | Co | 5 | Ce | 8.8 | 1.1 | 100 | 28 | 86 | 22 |
| Example 1 | | | | | | | | | | | |
| Working | Pt | 0.3 | Co | 5 | Ba | 7.8 | 0.9 | 100 | 30 | 52 | 17 |
| Example 2 | | | | | | | | | | | |
| Working | Pt | 0.3 | Co | 5 | Pr | 8.8 | 1.1 | 100 | 22 | 40 | 4 |
| Example 3 | | | | | | | | | | | |
| Working | Pt | 0.3 | Co | 5 | Ti | 4.1 | 1.5 | 100 | 13 | 34 | 9 |
| Example 4 | | | | | | | | | | | |
| Working | Pt | 0.7 | Co | 5 | Ce | 8.8 | 1.1 | 100 | 35 | 90 | 43 |
| Example 5 | | | | | | | | | | | |
| Working | Pt | 3 | Co | 5 | Ce | 8.8 | 1.1 | 100 | 85 | 94 | 65 |
| Example 6 | | | | | | | | | | | |
| Working | Pd | 0.3 | Mn | 5 | Ba | 7.8 | 0.9 | 100 | 42 | 63 | 44 |
| Example 7 | | | | | | | | | | | |
| Comparative | Pt | 0.3 | — | — | — | — | — | 100 | 4 | 10 | 0 |
| Example 1 | | | | | | | | | | | |
| Comparative | Pt | 0.3 | Co | 5 | — | — | — | 100 | 21 | 35 | 2 |
| Example 2 | | | | | | | | | | | |
| Comparative | Pt | 0.3 | Co | 5 | Mo | 6.5 | 1.8 | 100 | 1 | 4 | 1 |
| Example 3 | | | | | | | | | | | |
| Comparative | Pt | 0.7 | Co | 5 | — | — | — | 100 | 21 | 85 | 2 |
| Example 4 | | | | | | | | | | | |
| Comparative | Pt | 3 | Co | 5 | — | — | — | 100 | 21 | 93 | 2 |
| Example 5 | | | | | | | | | | | |
| Comparative | Pd | 0.3 | Mn | 5 | — | — | — | 100 | 35 | 52 | 28 |
| Example 6 | | | | | | | | | | | |
| Reference | Pt | 0.3 | Co | 5 | Ce | 8.8 | 1.1 | 100 | 15 | 77 | 16 |
| Example | | | | | | | | | | | |

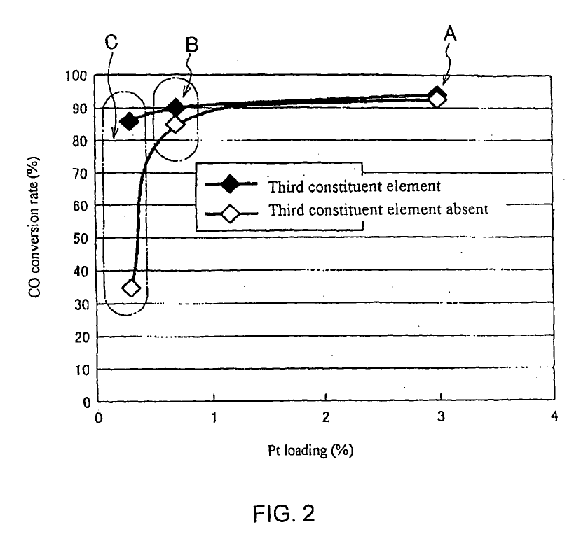

FIG. 2 illustrates the relationship between the Pt loading (%) and CO conversion rate (%) of both a catalyst 1 fabricated with the addition of a third constituent element 4 (shown with data point boxes solid) and a catalyst fabricated without the addition of a third constituent element (shown with data point boxes not filled in).

In FIG. 2, Pt loading level “A” shows a comparison of the CO conversion rates (%) of Working Example 6 and Comparative Example 5 when the Pt loading is 3%. From FIG. 2, one can see that there Is virtually no change in the value of the CO conversion rate between the cases of fabrication with and without the addition of a third constituent element 4, so no major meritorious effect of fabrication with the addition of a third constituent element 4 is seen.

In FIG. 2, Pt loading level “B” shows a comparison of the values of Working Example 5 and Comparative Example 4 when the Pt loading is 0.7%. Upon comparing the values of FIG. 2 at level B, one can see that a higher CO conversion rate (%) was obtained with Working Example 5 fabricated with the addition of a third constituent element 4.

In FIG. 2, Pt loading level “C” shows a comparison of the CO conversion rates (%) of Working Example 1 and Comparative Example 2 when the Pt loading is 0.3%. From FIG. 2 at level C, one can see that the sample obtained in Comparative Example 2 exhibited a higher CO conversion rate than that of the sample obtained in Comparative Example 1 where the alumina was loaded with the noble metal Pt alone, but a marked difference is seen in comparison to Working Example 1 that was fabricated with the addition of a third constituent element 4.

In this manner, when the Pt loading is 0.7% or less, or namely when the amount of Pt used is 0.7 g or less per liter volume of exhaust emission reduction catalyst, a major meritorious effect is obtained when the catalyst is fabricated with the addition of a third constituent element 4 in accordance with this invention, so it was found that adequate catalytic activity can be obtained even when the amount of Pt used is reduced.

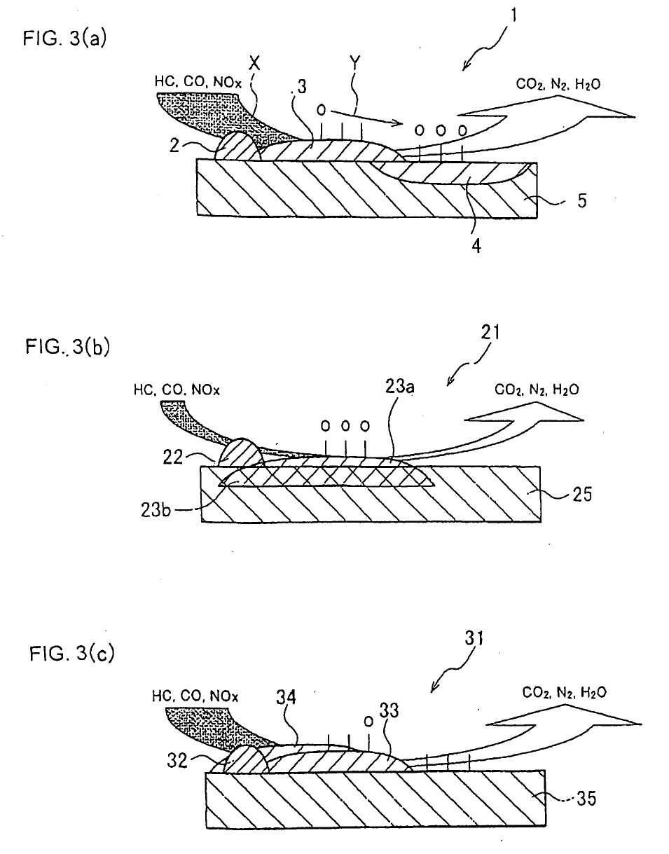

FIG. 3(a),(b) and (c) are explanatory diagrams illustrating the mechanism of removal of emissions by a catalyst obtained according to Working Example 1, Comparative Example 2 and the Reference Example, respectively. As shown in FIG. 3(a), the catalyst for use in exhaust emission control obtained in Working Example 1 is identical to that illustrated in FIG. 1. In Working Example 1, the porous carrier 5 is impregnated in advance with the third constituent element 4, made to form a complex oxide by firing at a high temperature of roughly 600° C. and furthermore loaded by being impregnated with both the noble metal 2 and transition metal compound 3. Thus, the transition metal compound 3 that forms a complex with the noble metal 2 is loaded atop the third constituent element 4 that forms a complex oxide with the porous carrier 5. In FIG. 3(a), “X” indicates exhaust gas containing NOₓ, CO and C₃H₆ moving in the direction of the arrow Y. At that time, the transition metal compound 3 is activated by the third constituent element 4, so oxygen within the complex is used for the oxidation of the third constituent element 4, resulting in the surface of the third constituent element 4 becoming oxygen-rich. Moreover, as the exhaust gas moves over the noble metal 2, transition metal compound 3 and third constituent element 4, the harmful components consisting of NOₓ, CO and C₃H₆ are removed and converted to CO₂, N₂ and H₂O, thereby reducing emissions from the exhaust gas.

In contrast, as shown in FIG. 3(b), the catalyst 21 obtained in Comparative Example 2 has a porous carrier 25 loaded with noble metal 22 and transition metal compound 23 in the state that they are in contact with each other. The transition metal compound 23 is loaded in a state such that it is rich in oxygen, so it forms a solid solution with the porous carrier 25. Moreover, as shown in FIG. 3(b), a portion 23a of the transition metal compound 23 becomes a layer rich in oxygen that is exposed from the surface of the porous carrier 25, but the lower portion 23b of this layer is in a state forming a solid solution within the porous carrier 25. In this catalyst 21, the transition metal compound 23 has virtually no catalytic activity, so the only catalytically active site is the surface of the noble metal 22. For this reason, the amount of exhaust gas that can be purified is less than with the catalyst 1 shown in FIG. 3(a).

As shown in FIG. 3(c), which corresponds to the Reference Example, the porous carrier 35 is loaded with noble metal 32 and transition metal compound 33 in the state that they are in contact with each other, and the third constituent element 34 is loaded upon the noble metal 32 and transition metal compound 33. Thus, the sites of catalytic activity are covered by the third constituent element 34, so the catalytic activity is reduced. Note that the catalyst for use in exhaust emission control 31 obtained in the Reference Example has the same values for the Pt loading, transition metal loading and loading of Ce, which is the third constituent element, as those of the catalyst for use in exhaust emission control 1 illustrated in FIG. 3(a), but gave results where each of the conversion rates were inferior to those of the catalyst 1.

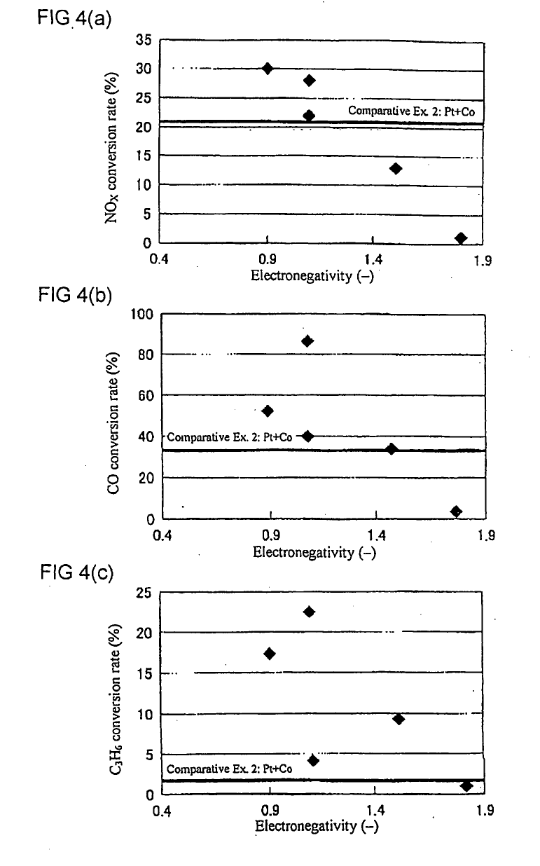

Even in the case that a third constituent element 4 is added, if the electronegativity of the third constituent element is greater than 1.5 as illustrated in Comparative Example 3, the catalytic activity drops, resulting in the catalytic activity becoming less than that of the sample obtained in Comparative Example 2 wherein the alumina is loaded with Pt and Co. Next, FIG. 4(a)-(c) illustrate the relationships between the conversion rates for NOₓ, CO and C₃H₆, respectively, and the electronegativity of the third constituent element 4 contained in the catalyst 1. The data points illustrated in FIGS. 4(a)-(c) are derived from data listed under Working Examples 1-4 and Comparative Example 3 in Table 1. As shown in FIG. 4(a), there is good correlation between the NOₓ conversion rate and the electronegativity of the third constituent element contained in the catalyst 1 so a lower electronegativity was found to give a higher NOₓ conversion rate. In comparison to the NOₓ conversion rate of 21% for Comparative Example 2 where alumina is loaded with Pt and Co, an increased NOₓ conversion rate was seen particularly In cases in which the electronegativity is 1.2 or less. In addition, as shown in FIG. 4(b), a certain degree of correlation is seen between the CO conversion rate and the electronegativity of the third constituent element 4 contained in the catalyst, so a lower electronegativity was found to give a higher CO conversion rate. In comparison to the CO conversion rate of 35% for Comparative Example 2 where alumina is loaded with Pt and Co, an increased CO conversion rate was seen particularly in cases in which the electronegativity is 1.2 or less. Moreover, as shown in FIG. 4(c), a certain degree of correlation is also seen between the C₃H₆ conversion rate and the electronegativity of the third constituent element contained in the catalyst so a lower electronegativity was found to give a higher C₃H₆ conversion rate. In comparison to the C₃H₆ conversion rate of 2% for Comparative Example 2 where alumina is loaded with Pt and Co, an increased C₃H₆ conversion rate was seen particularly in cases in which the electronegativity is 1.5 or less.

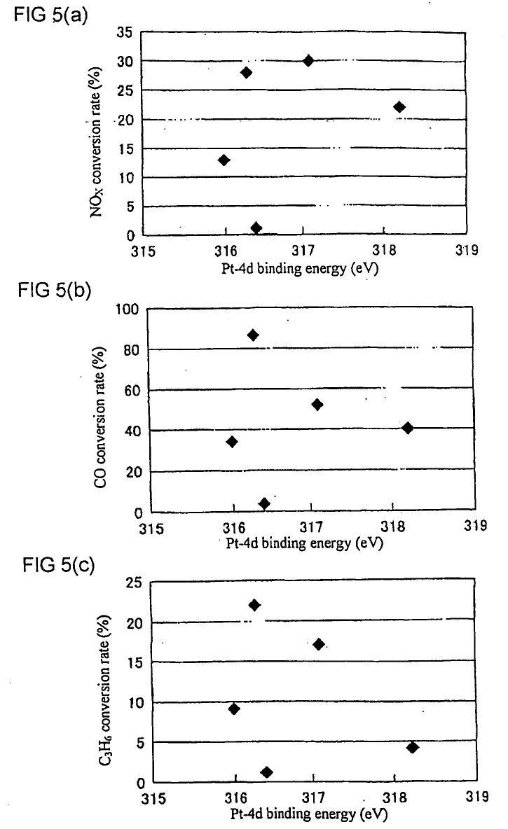

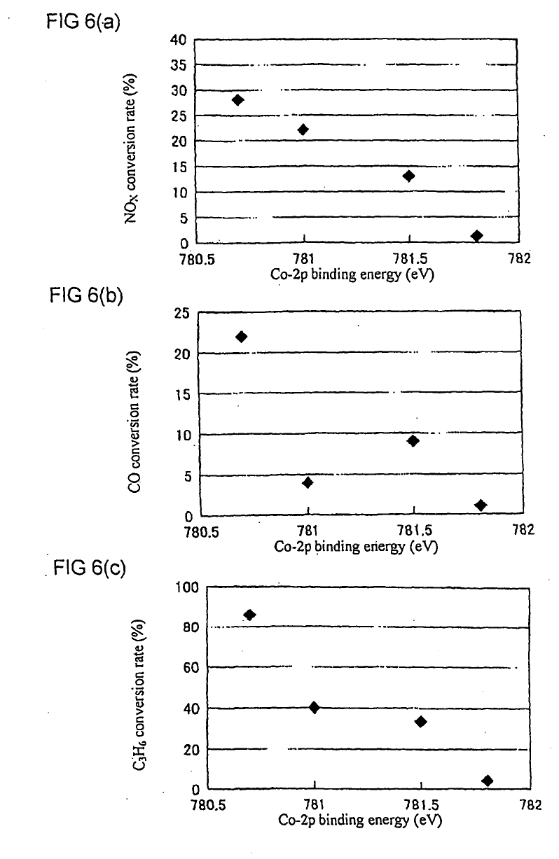

Next, FIG. 5(a)-(c) Illustrates the relationships between the conversion rates for NOₓ, CO and C₃H₆, respectively, and the value of the 4d binding energy of the Pt within the catalyst while FIG. 6(a)-(c) illustrates the relationships between the conversion rates for NOₓ, CO and C₃H₆, respectively, and the value of the −2p-binding energy of the Co within the catalyst. In addition, Table 3 below presents the third constituent elements added to the samples obtained in Working Examples 1-4 and Comparative Example 3, along with the values of the 4d binding energy of the Pt within the sample as measured by X-ray photoelectron spectroscopy, the values of the 2p binding energy of the Co within the sample (B₂) as measured by X-ray photoelectron spectroscopy, the Co-2p shifts which are the differences (B₂−B₁) between B₂ and the values of the 2p binding energy of the Co in the metallic state (B₁), and the conversion rates for NOₓ, CO and C₃H₆.

TABLE 3

| | | | | | Conversion rate (250° C.) | | |
|---|---|---|---|---|---|---|---|
| | Third | Bindinq energy (eV) | | Co-2p | NO_{X} | | |
| | constituent | Pt-4d | Co-2p | shift | (%) | CO (%) | C₃H₆ (%) |
| Working Example 1 | Ce | 316.3 | 780.7 | 3.1 | 28 | 86 | 22 |
| Working Example 2 | Ba | 317.1 | Not measurable due | | 30 | 52 | 17 |
| | | | to overlap with Ba | | | | |
| Working Example 3 | Pr | 318.2 | 781.0 | 3.4 | 22 | 40 | 4 |
| Working Example 4 | Ti | 316.0 | 781.5 | 3.9 | 13 | 34 | 9 |
| Comparative Example 3 | Mo | 316.4 | 781.8 | 4.2 | 1.0 | 4.0 | 1.0 |

*Co metal is 777.6 eV

From FIG. 5(a)-(c), no correlation is seen between the value of the binding energy of the 4d orbital of Pt and the NOₓ, CO and C₃H₆ conversion rates. Based on these results, the oxidation/reduction state of the noble metal was found not to be affected by the addition of the third constituent element, and the addition of the third constituent element was not found to increase the catalytic activity of the noble metal.

In addition, from FIG. 6(a)-(c), a correlation is seen between the value of the binding energy of the 2p orbital of Co and the NOₓ, CO and C₃H₆ conversion rates. Moreover, Comparative Example 3 wherein the Co-2p shift was 4.2 eV exhibited markedly lower NOₓ, CO and C₃H₆ conversion rates than those of Working Examples 1-4 wherein the Co-2p shift was 3.9 eV or less. Based on these results, the addition of the third constituent element was found to change the oxidation/reduction state of the transition metal compound, putting it into a reduction state, thereby increasing the catalytic activity of the transition metal compound. Based on the above results, the addition of a third constituent element 4 was found to promote the activation of the transition metal compound 3, so a catalyst 1 that can maintain its catalytic activity even in the case that the amount of noble metal 2 is reduced can be obtained.

It is therefore intended that the foregoing detailed description be regarded as illustrative rather than limiting, and that it be understood that it is the following claims, including all equivalents, that are intended to define the spirit and scope of this invention.

1. A catalyst (1) for use in exhaust emission control comprising:
a porous carrier (5);
a first constituent (2) including a noble metal supported on the porous carrier;
a second constituent (3) including a transition metal compound supported on the porous carrier, such that the first constituent and the second constituent form a first constituent-second constituent complex; and
a third constituent element (4) having an electronegativity of about 1.5 or less supported on the porous carrier (5), the third constituent element being in contact with at least a portion of the first constituent-second constituent complex.

2. The catalyst (1) according to claim 1 wherein at least a portion of the third constituent element (4) is impregnated into the porous carrier (5).

3. The catalyst (1) according to claim 1 wherein at least a portion of the third constituent element (4) forms a complex oxide with the porous carrier (5).

4. The catalyst (1) according to claim 1 wherein at least a portion of the first constituent-second constituent complex is deposited on the third constituent element (4).

5. The catalyst (1) according to claim 1 wherein the noble metal is selected from the group consisting of ruthenium, rhodium, palladium, silver, iridium, platinum, gold, and mixtures thereof.

6. The catalyst (1) according to claim 1 wherein the transition metal compound includes a transition metal selected from the group consisting of manganese, iron, cobalt, nickel, copper, zinc, and mixtures thereof.

7. The catalyst (1) according to claim 1 wherein the third constituent element (4) is selected from the group consisting of manganese, titanium, zirconium, magnesium, yttrium, lanthanum, cerium, praseodymium, neodymium, calcium, strontium, barium, sodium, potassium, rubidium, cesium, and mixtures thereof.

8. The catalyst (1) according to claim 1 wherein the third constituent element (4) has an electronegativity of about 1.2 or less.

9. The catalyst (1) according to claim 1 wherein
the transition metal compound includes a transition metal,
the transition metal has a 2p binding energy having a first value (B₂),
the transition metal in a metallic state has a 2p binding energy having a second value (B₁), and
the difference between B₂ and B₁ (B₂−B₁) is 3.9 eV or less.

10. The catalyst (1) according to claim 1 wherein the noble metal is present in an amount of about 0.7 grams or less per 1 liter volume of the catalyst.

11. The catalyst (1) according to claim 1 wherein the first constituent-second constituent complex is homogeneous.

12. A method of manufacturing a catalyst (1) for use in exhaust emission control, the method comprising the steps of:
impregnating a porous carrier (5) with a constituent element (4) having an electronegativity of about 1.5 or less;
subsequently loading the porous carrier (5) with a first constituent (2) including a noble metal and a second constituent (3) including a transition metal compound such that the first constituent (2) and the second constituent (3) form a complex, and such that the first constituent-second constituent complex is in contact with at least a portion of the constituent element (4).

13. The method according to claim 12 wherein at least a portion of the constituent element (4) forms a complex oxide with porous carrier (5).

14. The method according to claim 12 wherein the noble metal is selected from the group consisting of ruthenium, rhodium, palladium, silver, iridium, platinum, gold, and mixtures thereof.

15. The method according to claim 12 wherein the transition metal compound includes a transition metal selected from the group consisting of manganese, iron, cobalt, nickel, copper, zinc, and mixtures thereof.

16. The method according to claim 12 wherein the constituent element (4) is selected from the group consisting of manganese, titanium, zirconium, magnesium, yttrium, lanthanum, cerium, praseodymium, neodymium, calcium, strontium, barium, sodium, potassium, rubidium, cesium, and mixtures thereof.

17. The method according to claim 12 wherein the constituent element (4) has an electronegativity of about 1.2 or less.

18. The method according to claim 12 wherein
the transition metal compound includes a transition metal,
the transition metal has a 2p binding energy having a first value (B₂),
the transition metal in a metallic state has a 2p binding energy having a second value (Be), and
the difference between B₂ and B₁ (B₂−B₁) is 3.9 eV or less.

19. The method according to claim 12 wherein the step of loading the porous carrier (5) with the first constituent (2) including a noble metal includes loading the porous carrier (5) with one or more noble metals present in an amount of about 0.7 grams or less per 1 liter volume of the catalyst.

20. The method according to claim 12 wherein first constituent-second constituent complex is homogeneous.
